(19) United States
(12) Patent Application Publication
(10) Pub. No.: US 2006/0226940 A1
(43) Pub. Date: Oct. 12, 2006

(54) Method and apparatus for setting a sensor AFM with a superconducting magnet

(75) Inventors: Wen-yaung Lee, San Jose, CA (US); Jinshan Li, San Jose, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 11/244,618

(22) Filed: Oct. 5, 2005

Related U.S. Application Data
(60) Provisional application No. 60/669,509, filed on Apr. 7, 2005.

(51) Int. Cl. H01F 6/00

(52) U.S. Cl. 335/216

(57) ABSTRACT

A method for constructing a magnetoresistive sensor using a horizontally disposed superconducting magnetic tool. The superconducting magnetic tool is capable of generating very high magnetic fields for sustained periods of time to effectively set the magnetizations of magnetoresitive sensors having a very high pinning field. The supermagnetic tool has a ceramic tube surrounded by a superconducting coil. The tube has a longitudinal axis that is oriented horizontally, thereby providing numerous important benefits, such as: facilitating manipulation of the sensor containing wafer within the tool; facilitating loading of the wafer into the tool; preventing temperature and field gradients within the wafer during the anneal; and facilitating maintenance and storage of the tool by limiting the height of the tool.

### BACKGROUND OF THE INVENTION

### Field of the Invention

The present invention relates to the construction of magnetoresistive sensors and more particularly to the use of a superconducting magnet to set the magnetization of magnetic layers in a magnetoresistive sensor.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Magnetization of the pinned layer is usually fixed by exchange coupling one of the ferromagnetic layers (AP1 ) with a layer of antiferromagnetic material such as PtMn. While an antiferromagnetic (AFM) material such as PtMn does not in and of itself have a magnetization, when exchange coupled with a magnetic material, it can strongly pin the magnetization of the ferromagnetic layer.

The demand for ever increasing data rate and data density has led a push to develop magnetoresistive sensors having ever smaller size and ever increased performance. However, as sensors become smaller, a challenge that arises is that the strength of the pinning field decreases. The pinning field of the sensor can be understood as the strength of magnetic field that is needed to overcome the pinning of the magnetization of the pinned layer. For example, if the pinning field is very small, the magnetic pinning can be easily overcome, and the orientation of the magnetization of the pinned layer can easily switch from its desired orientation to an orientation that is 180 out of phase. This is known as “amplitude flipping” and results in catastrophic head failure. Events that can lead to amplitude flipping include heat spikes or mechanical stresses such as from head disk contact or electrostatic discharge. Therefore, in order for a sensor to be reliable and robust in use, the sensor must have a very strongly pinned pinned layer (ie. a high pinning field).

Mechanisms and processes have been proposed to increase the pinning field of a sensor. However, increasing the pinning field of the pinned layer also means that an increased magnetic field is needed to set the pinned layer magnetization during manufacture. For example, in order to set the magnetization of a pinned layer, the sensor is heated above the blocking temperature of the AFM layer. The blocking temperature is the temperature at which the AFM layer ceases to be antiferromagnetic and at which exchange coupling with the pinned layer is lost. While the sensor is held at a temperature above the blocking temperature, a magnetic field is applied to the sensor. This field magnetizes the magnetic pinned layer closest to the AFM layer in a desired direction perpendicular to the air bearing surface (ABS). The application of this magnetic field continues while the sensor is cooled to a temperature below the blocking temperature, at which point exchange coupling between the AFM layer and its closest magnetic layer pins the pinned layer in the desired orientation.

The magnetic field used to set the pinned layer has traditionally been supplied by a standard solenoid electromagnet. Such a magnetic has magnetic core with an electrically conductive wire wrapped around the core. The core forms first and second poles between which the wafer sits during application of the magnetic field. This form of electromagnet has been suitable for prior art sensors where a magnetic field on the order of only 1.3 Tesla has been needed to set the pinned layer. However, as mentioned above much larger fields are needed to set the pinned layers of future generation sensors. For example, magnetic fields of 4 Tesla and higher will be needed.

Therefore, there is a strong felt need for a mechanism for setting pinned layers in sensors having very high pinning fields. Such a pinning mechanism will preferably include a means for producing very high magnetic fields, on the order of 4 Tesla or higher. A means for producing such a high magnetic field would also preferably be practical for the mass production of sensors, such as by the use of a tool that can be easily accessed and which can be housed and maintained in a standard building or clean-room. Such a tool for producing a wafer would also allow for convenient manipulation of the wafer within the area in which the magnetic field is maintained.

### SUMMARY OF INVENTION

This invention deals with a method and apparatus for setting a sensor AFM with superconducting magnet with 5 Tesla field at elevated temperature. The current designs orient the superconducting magnet/anneal vacuum chamber in a vertical direction. The problems with the vertical design are that the wafers have to “standup” as oppose to lying flat. “Standup” experiences more temperature gradient. In addition, vertical design makes wafer manipulation (rotating wafers) during anneal process very unreliable. The present invention can be embodied in a horizontal superconducting magnet design where the annealing chamber is horizontal and wafers can be annealed lying flat with uniform temperature/field and reliable rotation capability. Many modifications need to be made in order to rotate the magnets from the conventional way and handle the wafers horizontal as opposed to vertical.

Conventional electromagnets used in the production of giant magnetoresistive (GMR) and tunneling magnetoresistive (TMR) heads for the setting of the magnetization of pinned layer structures, such as antiparallel (AP) pinned structures, rely on large planar pole caps of large dimension made from the highest saturation magnetization materials, such as Fe or CoFe alloys. The fields in the air gap, or working space, between the pole caps of the electromagnet generated by these electromagnets are limited by the saturation magnetization of these alloys which for Fe is 21.5 KG or 2.15 T, and for Co50Fe50 alloy, about 23 KG or 2.3 T. Higher fields, on the order of 5 T, are required for setting the new thin Ru AP-pinned structures. Although high fields greater than 2 T can be obtained with conventional solenoidal electromagnets based on the Bitter magnet design, the size and bulk of such magnets, the non-uniformity of the fields generated, the short duration of sustained fields, the substantial cost of high current generation facilities, and cooling water requirements to dissipate the heat generated by Ohmic conductors makes such designs impracticable in a manufacturing environment. Designs based on superconducting magnets overcome these limitations: the size limitation, because superconducting magnets are small and relatively compact due to the higher current carrying capacity of superconductors; the field uniformity limitation, because superconducting magnets can be made with large diameters; the field duration limitation, because superconducting magnets can conduct a current for as long as their temperature is maintained at or below the critical superconducting temperature; the substantial cost of high current generation facilities, because, unlike Bitter magnets, superconducting magnets do not require Megawatt power generation facilities; and the cooling water requirements, because superconducting magnets do not generate Ohmic heat due to their negligible electrical resistance. The ability to generate large fields without the attendant costs and limitations of conventional solenoidal electromagnets makes superconducting magnets ideal for setting the magnetization of the thin Ru and thin Ru alloy AP-pinned structures in advanced GMR and TMR head wafers, which are 5″ or greater in diameter. Moreover, the ability to sustain high, uniform, magnetic fields over large areas provided by superconducting magnets is an absolute requirement for the long term, 2 hours or longer, magnetic anneals at 200 degrees C. or greater required to set the magnetization in thin Ru AP-pinned structures.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic diagram of a disk drive system;

FIG. 2 is a perspective view of a wafer on which a plurality of magnetic heads are formed;

FIG. 3 is a cross sectional view of a wafer having a plurality of magnetoresistive sensors formed thereon;

FIG. 4 is an ABS view of an example of a sensor that could be formed on the wafer of FIG. 3;

FIGS. 5-6 are schematic views of a superconducting magnetic tool in which sensors on a wafer can be annealed to set the magnetization of the pinned layer;

FIG. 7 is a schematic view of a superconducting magnetic tool according to an alternate embodiment of the invention in which sensors can be annealed;

FIG. 8 is an external view of a tool for annealing magnetoresitive sensors; and

FIG. 9 is a flowchart illustrating a method of constructing a sensor.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

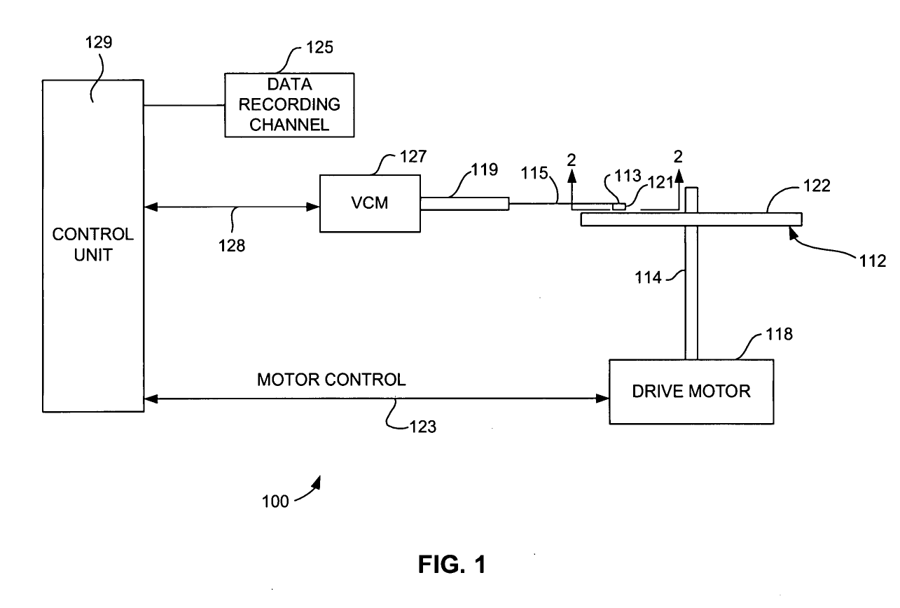

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

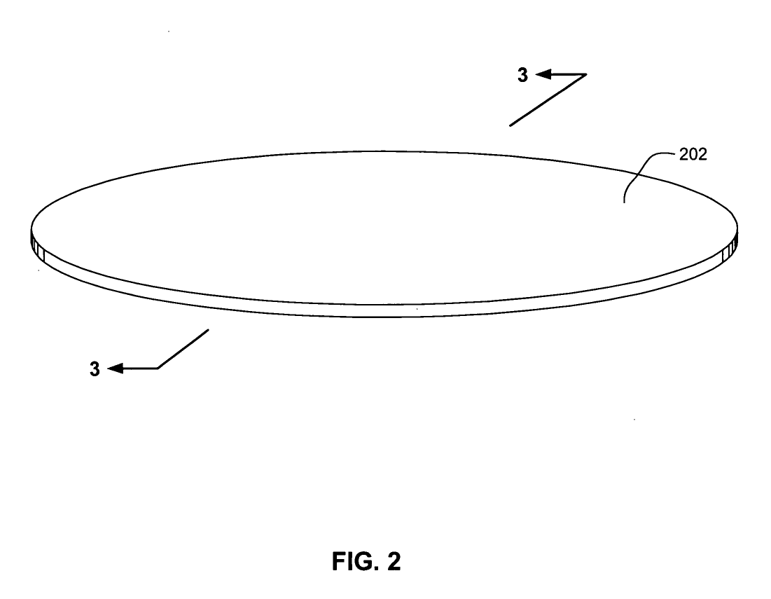

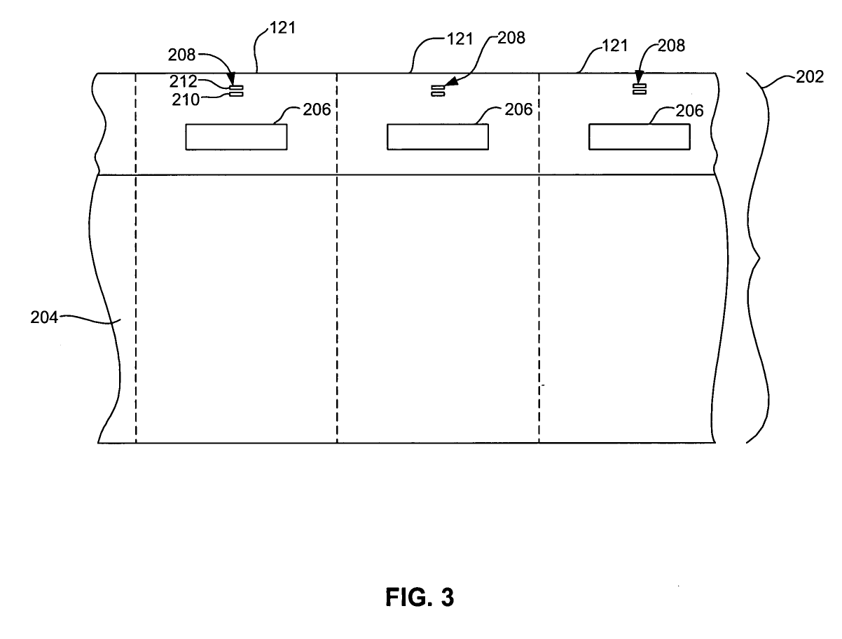

With reference now to FIG. 2, the magnetic head assemblies 121 (FIG. 1) are manufactured on a wafer 202, with thousands of such heads being manufactured on a single wafer 202. FIG. 3 shows an enlarged cross section of the wafer with several magnetic heads 121 formed thereon. The wafer includes a substrate 204, which may be aluminum titanium carbide (AlTiC) or some other material. Each head 121 includes a magnetoresistive sensor 206 and an inductive write element 208. For purposes of the clarity, the cross section shown in FIG. 3 is taken at a location where an air bearing surface (ABS) would be located, so that only a first and second pole tip 210, 212 of each write element can be seen. The read and write elements 206, 208 are embedded within non-magnetic, electrically insulating material 214 such as alumina.

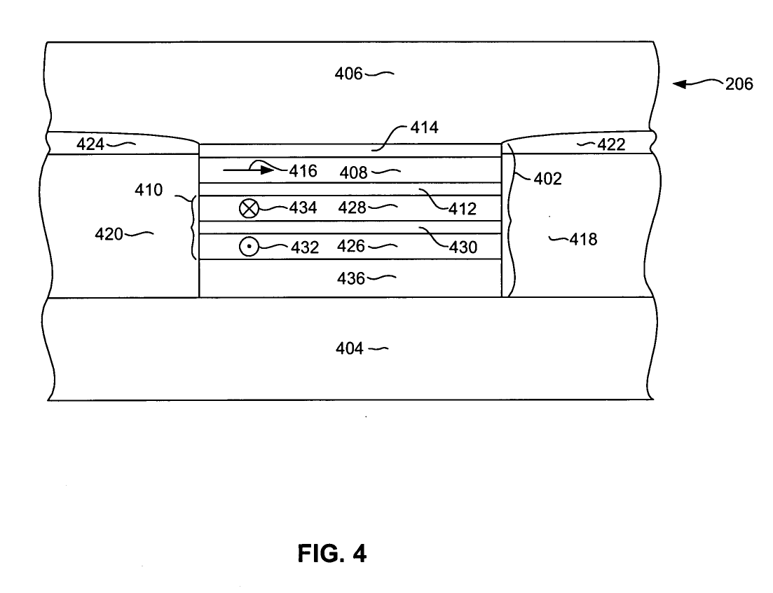

With reference now to FIG. 4, the structure of a read sensor 206 can be seen in more detail. FIG. 4 shows a view of a sensor as it would appear when viewed from the air bearing surface (ABS) of a finished head (ie. as viewed from the surface that would face the magnetic medium 122 (FIG. 1) during use. The sensor 206 includes a sensor stack 402 sandwiched between first and second non-magnetic, electrically insulating gap layers 404, 406. The sensor described herein is described as a current in plane sensor for purposes of illustration. However, if the senor were embodied in a current perpendicular to plane (CPP) sensor, the gap layers 404, 406 would be replaced with electrically conductive leads layers.

The sensor stack 402 includes a free layer 408, a pinned layer structure 410 and a non-magnetic, electrically conductive spacer layer 412 sandwiched between the free layer 408 and pinned layer 410. The free layer may be constructed of magnetic material such as CoFe, NiFe or a combination of these. The spacer layer 412 may be constructed of, for example, Cu. Although described herein as a GMR sensor, if the sensor were a tunnel valve, the layer 412 would be a thin, non-magnetic, electrically insulating barrier layer. A capping layer 414 such as Ta may be provided at the top of the sensor stack 402 to prevent damage to the sensor layers during manufacture.

The free layer 408 has a magnetization 416 that is biased in a desired direction parallel with the ABS. Biasing of the free layer may be provided by first and second hard bias layers 418, 420 formed at either side of the sensor stack 402. The bias layers 418, 420 may be constructed of, for example CoPt or CoPtCr. First and second electrically conductive lead layers 422, 424 may be provided at the top of each bias layer. The leads 422, 424 may be constructed of, for example Cu, Au, Rh or some other electrically conductive material.

With continued reference to FIG. 4, the pinned layer structure 410 includes first and second magnetic layers AP1 426 and AP2 428, which are separated from one another by an antiparallel coupling layer 430, which can be constructed of, for example, Ru. The first and second magnetic layers can be constructed of a material such as CoFe. The AP1 and AP2 layers are strongly antiparallel coupled so that they have magnetizations 432, 434 that are oriented antiparallel to one another. A layer of antiferromagnetic material (AFM layer) 436 is exchange coupled with the AP1 layer, which strongly pins the magnetic magnetization 432 of the AP1 layer 426. The AFM layer 436 can be constructed of, for example, PtMn, IrMn or some similar material.

Setting the magnetizations 432, 434 of the AP1 and AP2 layers 426, 428 can be accomplished by an annealing process. The annealing process may include raising the sensor 206 to a temperature that is close to the blocking temperature of the AFM layer 436. The blocking temperature is the temperature at which exchange coupling between the AFM layer 436 and the AP1 layer 426 is lost. For example, the blocking temperature of PtMn is about 350 degrees C. When annealing sensors having PtMn AFM layers, the wafer is raised to a temperature greater than 200 degrees C., such as 215 to 315 degrees C. or about 265 degrees C. IrMn has a slightly lower blocking temperature. Therefore, when annealing sensors having IrMn AFM layers, the wafer is raised to a temperature that is also greater than 200 degrees C., such as 190 to 290 degrees or about 240 degrees C. While the sensor is held at this temperature, a magnetic field is applied to the sensor to orient the magnetizations 432, 434 of the AP1 and AP2 layers 426, 428 in a desired direction perpendicular to the ABS. While maintaining the magnetic field, the sensor is cooled to a temperature well below its blocking temperature, or to about room temperature (around 20 degrees C.). In one method of setting pinned layer 410, the magnetic field used to orient the magnetizations, is sufficiently strong that it overcomes the antiparallel coupling between the AP1 and AP2 layers 426, 428. This causes the magnetizations 432, 434 to point in the same direction while the sensor is held above the blocking temperature of the AFM layer 436. When the sensor is cooled and the magnetic field is removed, the magnetization 434 rotates 180 degrees due to the antiparallel coupling between the layers 432, 434, while the magnetization 432 of the AP1 layer 426 remains oriented in the direction that it was oriented during application of the magnetic field. Strong exchange coupling between the AFM and the AP1 layer 426 keeps the magnetization 432 strongly pinned in this direction.

As can be appreciated, a tool is required to supply the magnetic field for annealing the pinned layer as described above. Prior art sensors have been annealed in a magnetic field provided by a solenoid magnet, based on the Bitter magnet design. Such magnets include a ferromagnetic core that forms first and second poles and an electrically conductive coil wrapped around the core. The wafer on which the sensors are manufactured is placed between the poles of the magnet, where a magnetic field extending from one pole to the other sets the pinned layer magnetization.

As discussed above in the Background of the Invention, sensor performance demands require ever increased pinning fields. These increased pinning fields, require higher magnetic fields for setting the pinned layer than were previously required. A conventional solenoid magnet such as that described can produce a magnetic field on the order of 1 to 3 Tesla or about 1.3 Tesla Tesla. Current and future generation sensors require fields on the order of 5 Tesla in order to effectively set the magnetizations of the pinned layer. Although high fields greater than 2 T can be obtained with conventional solenoidal electromagnets based on the Bitter magnet design, the size and bulk of such magnets, the non-uniformity of the fields generated, the short duration of sustained fields, the substantial cost of high current generation facilities, and cooling water requirements to dissipate the heat generated by Ohmic conductors makes such designs impracticable in a manufacturing environment. To set an AP pinned structure as described above, the wafer must be held within the magnetic field for 2 hours or greater at a temperature on the order of 200 degrees Celsius or greater.

Superconducting magnetic tools have been developed that are capable of generating the high magnetic fields necessary to anneal current and future generation sensors. As mentioned above, in the Summary of the Invention, designs based on superconducting magnets overcome many of the limitations of conventional solenoid electromagnets. For example, the size limitation can be overcome, because superconducting magnets are small and relatively compact due to the higher current carrying capacity of superconductors. Superconducting magnets overcome field uniformity limitations, because superconducting magnets can be made with large diameters. The field duration limitation is overcome, because superconducting magnets can conduct a current for as long as their temperature is maintained at or below the critical superconducting temperature. Furthermore, the substantial cost of high current generation facilities is not an issue, because, unlike Bitter magnets, superconducting magnets do not require Megawatt power generation facilities, In addition, the cooling water requirements are virtually eliminated, because superconducting magnets do not generate Ohmic heat due to their negligible electrical resistance. The ability to generate large fields without the attendant costs and limitations of conventional solenoidal electromagnets makes superconducting magnets ideal for setting the magnetization of the thin Ru and thin Ru alloy AP-pinned structures in advanced GMR and TMR head wafers, which are 5″ or greater in diameter. Moreover, the ability to sustain high, uniform, magnetic fields over large areas provided by superconducting magnets is an absolute requirement for the long term, 2 Hr or longer, magnetic anneals at 200 C or greater required to set the magnetization in thin Ru AP-pinned structures.

However, previously constructed superconducting magnets are unsuitable for use in annealing magnetoresistive sensors. Previously developed superconducting magnets include a ceramic tube oriented vertically with a superconducting coil surrounding the ceramic tube. A heating element wrapped around the ceramic tube is used to heat the wafer to the desired temperature during the anneal. In order to expose the wafer to a magnetic field, the wafer must be held within the ceramic tube. With currently available tools, this means that the wafer must be loaded into the tube through the bottom or top of the tube, making loading of the wafer extremely difficult.

In addition, the vertical orientation of the tube makes manipulation of the wafer within the tube extremely difficult. The magnetic field within the tube is oriented along the length of the tube, which, when the tube is oriented vertically, means that the wafer must be held on its edge in order to correctly orient the sensors within the magnetic field. Such orientation requires that the wafer be held on some sort of complex clamping device that can hold and manipulate the wafer in a vertical position. Keeping in mind that the wafer must be maintained at a temperature greater than 200 degrees C. in the presence of a 5 Tesla magnetic field for a duration greater than 2 hours, any complex mechanism for manipulating the wafer would suffer from serious reliability and maintenance problems.

In addition, in order to maintain such high magnetic fields using a superconducting magnet, the inside of the tube must be evacuated. This makes the use of a complex wafer clamping and manipulating device even more challenging, since the actuation mechanism must either be located within the harsh environment within the evacuated chamber or must pierce the chamber, making evacuation more difficult.

In addition, housing and maintaining such a tool poses a great challenge. The ceramic tube of such a device has a length along its axis of about 6 feet. Since the tube is oriented vertically, the tool cannot be housed within a standard clean-room having a ceiling of only about 12 feet. For example, in order to maintain such a vertically oriented tool and access the inside of the tool to load a wafer, an operator would have to access the top of the tool at a height of about 14 feet.

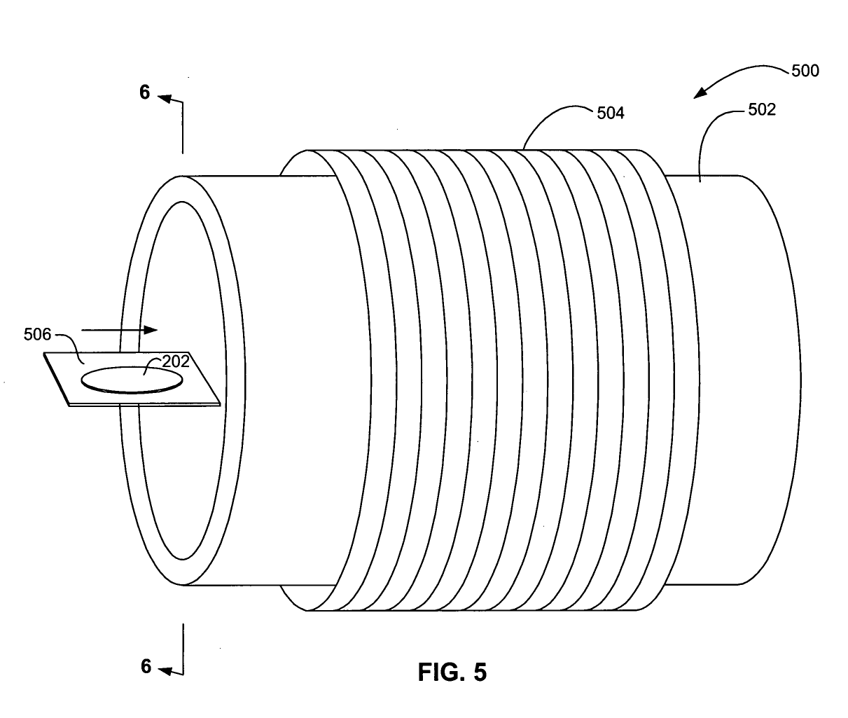

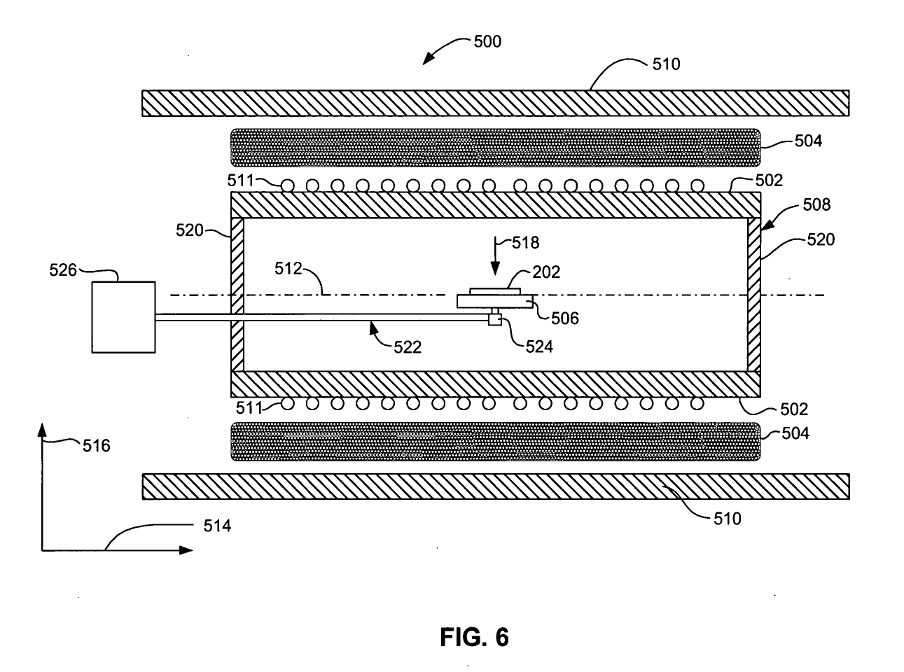

FIGS. 5 and 6 schematically illustrate a superconducting annealing tool 500 according to an embodiment of the invention. With reference to FIG. 5, at its most basic, the tool 500 includes a ceramic tube 502 which can be for example quartz, and a superconducting coil 504 forming a magnet wrapped around the ceramic tube 502. The wafer 202, held on a platter, table or tray 506 enters the tube 502 through a hole in an end of the tube.

With reference now to FIG. 6, which shows a schematic view of the tool 500 in greater detail and in cross section, the tool 500 includes an evacuation chamber 508, which can be formed by capping the ends of the ceramic tube 502 with caps 520 and providing a pump (not shown) to evacuate the tube. A magnetic shield 510 surrounds the magnet 504, to protect the operators from exposure to the high magnetic fields produced by the tool 500. At least one of the caps 520 at the end of the tube 502 is configured with a door for inserting the wafer 202.

An electrically conductive heating coil 511 surrounds the vacuum chamber 508. This heating coil can be used to raise the temperature of the wafer 202 inside the chamber to a temperature that is necessary to anneal the sensors 206 as described above.

The tube 502 has a longitudinal axis 512 that is oriented with relation to a horizontal plane 514 and a vertical plane 516. The longitudinal axis 502 of the tool 500 is configured to be oriented substantially parallel with the horizontal plane 514 and substantially perpendicular to the vertical plane 516. However, the axis 512 may be at an angle of, for example, 0-30 degrees with respect to horizontal 514. Similarly, gravity in the environment of the tool (represented as a vector 518) is oriented in a vertical direction perpendicular to the longitudinal axis 512 of the ceramic tube 502.

Orienting the tool 500 so that the longitudinal axis is substantially parallel with the horizon (horizontal plane 514) provides numerous substantial advantages over prior art designs. For example, the wafer 506 can be easily loaded through an end of the tube 502 through a door or opening in one of the caps 520. This makes loading of the wafer much easier, since the end of the tube 502 is located at an elevation that is accessible to an operator standing on the ground, as compared with requiring the operator to climb up a ladder or scaffold to reach the end of the tube if it were oriented vertically.

Furthermore, the wafer can be easily held on the platter 506 without the use of any complex clamping device, because the wafer 202 can be held on the platter 506 with the assistance of gravity 518. A support structure 522 may be provided to support the platter 506 within the housing. The support structure 522 may include an actuator mechanism 524 and servo device 526 to orient or rotate the platter 506 while it is within the tube 502. Optionally, the actuator mechanism may be eliminated, simplifying the design and resulting in improved maintenance and reduced manufacturing cost. If the actuator 524 and servo 526 are not included, the proper orientation of the wafer can be ensured by placing the wafer on the platter in the desired orientation and then loading the platter into position within the tube 502. Advantageously, since the wafer can be held on the platter 506 by gravity, the mechanism for supporting the wafer within the tube 502 can be greatly simplified.

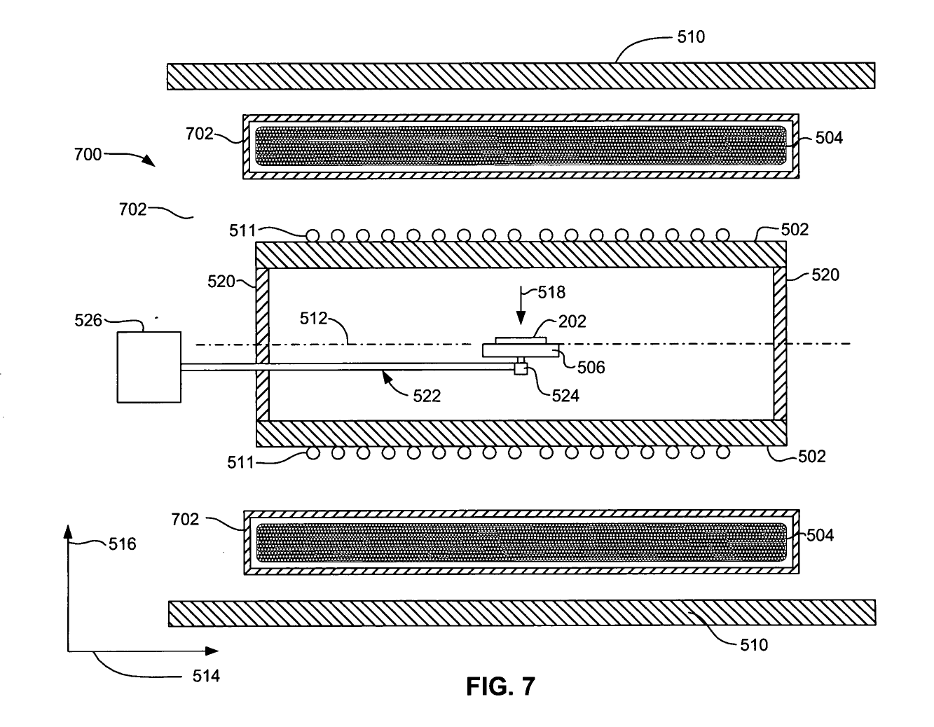

With reference now to FIG. 7, in another embodiment of the invention, a vacuum chamber 702 that is separate from the ceramic tube 502 can provided for evacuating the atmosphere surrounding the magnetic coil 504. This vacuum chamber 702 can have a toroidal or doughnut shape, with the ceramic tube 502 extending through the hole in the center of the doughnut. This separate evacuation chamber 702 thermally isolates the magnetic coil 504, and assists in keeping the coil 504 at the very low temperatures (around 9 degrees Kelvin) needed to maintain the coil in a solid state and enjoy the superconductive properties of the coil.

As mentioned above, in order to maintain the superconductive properties of the magnetic coil 504, the coil must be kept at a very low temperature. For example, the coil 504 can be constructed of NbTi, which must be kept at a temperature of about 9 degrees Kelvin. This low temperature can be maintained by a process that includes cooling the coil 504 using a cooling system having refrigerant conduit coil (not shown) and compressor (not shown) and using a material such as He a refrigerant. Cooling can be further improved by keeping the coil evacuated, as discussed with reference to FIG. 7.

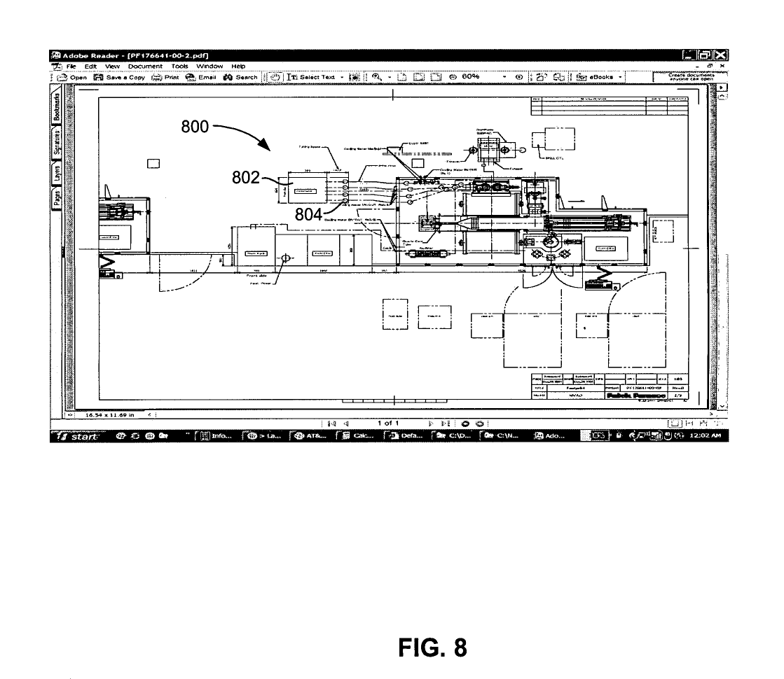

FIG. 8 shows a perspective view of a tool 800 according to an embodiment, shown from the outside. FIG. 8 shows a stack of wafers 802 outside of the tool 800, illustrating the ease of access of the end of the tool 800 for loading wafer into the tool 800.

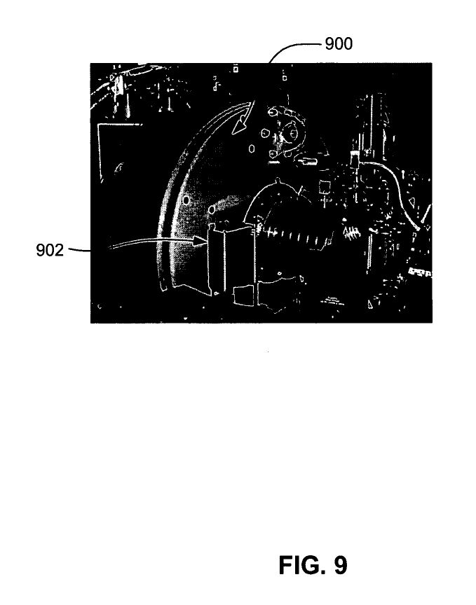

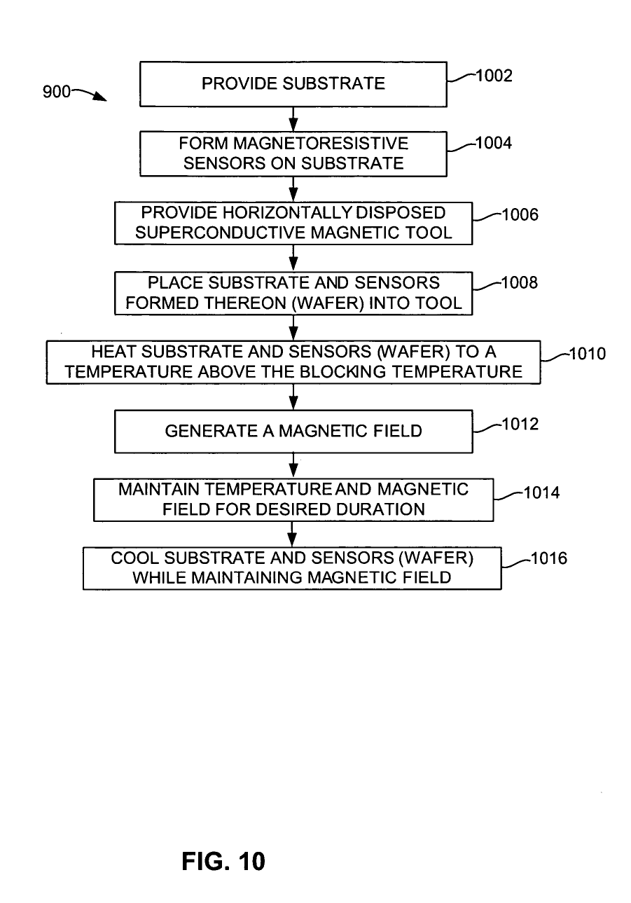

With reference now to FIG. 9, a method 900 for manufacturing a magnetoresistive sensor is described. The method 900 begins with a step 902 of providing a substrate. The substrate can be a wafer constructed of, for example aluminum titanium carbide (AlTiC) or could be some other material such as Si. Then, in a step 904 a plurality of sensors are formed on the substrate (wafer). The sensors may include a pinned layer structure, a free layer structure and a non-magnetic spacer or barrier layer sandwiched between the free layer and the pinned layer. The pinned layer structure may include first and second magnetic layers AP1 and AP2 separated from one another by a coupling layer such as Ru. One of the magnetic layers AP1 may be exchange coupled with a layer of antiferromagnetic material (AFM) layer. The AFM layer has a blocking temperature, which is the temperature at which the AFM layer loses its antiferromagnetic properties and loses exchange coupling with the AP1 layer. In a step, 906 a horizontally disposed superconductive magnetic tool is provided. The tool includes a ceramic tube, which may be constructed of quartz and which is surrounded by a superconductive coil that is wrapped around the tube. The tube has a longitudinal axis that is oriented substantially horizontally. The tool may also include a platter connected with a support structure, the support structure being configured to move the platter laterally into the tube along a direction parallel with the longitudinal axis of the tube. The support structure may also be configured to rotate the platter about an axis that is substantially vertical (ie. rotate the platter in a horizontal plane), or may be configured so that the platter is fixed so that it does not rotate. In a step, 908 the wafer (substrate and sensors) is placed into the superconducting magnetic tool. The wafer can be loaded into the tool, by placing it on the platter, where the wafer can be held by gravity (rather than clamped) due to the horizontal orientation of the tube.

In a step, 910, the wafer is heated to a temperature near the blocking temperature of the AFM layers of the sensors formed on the substrate. This temperature may be 215-315 degrees C. or about 265 degrees C., if a PtMn AFM layer is used in the sensor. The annealing temperature may be about 190-290 degrees C. or about 240 degrees C. if an IrMn AFM layer is used. Then, in a step 912, the tool is activated to generate a magnetic field within the tube, where the wafer is located. This magnetic field may be 4-6 Tesla or about 5 Tesla. The magnetic field is generated by conducting a current through the superconductive coil surrounding the tube. Since the superconducting coil generates negligible Ohmic heat, a large current can be supplied for a prolonged amount of time.

With reference still to FIG. 9, in a step 914 the magnetic field and temperature of the wafer are both maintained for a desired duration. This duration is preferably greater than 1 hour can be, for example 1-3 hours or about 2 hours, or could be 5 or more hours. Then, in a step 916, the wafer is cooled well below the blocking temperature, such as to a temperature below 100 degrees C. or to room temperature. The magnetic field is maintained while cooling the wafer to the desired temperature, in order to ensure that when the AFM layer becomes anti-ferromagnetic and exchange couples with the AP1 layer of the pinned layer, the AP1 layer will be magnetized in the desired direction perpendicular to the plane in which the air bearing surface (ABS) will be. After the wafer has been brought down to the desired temperature (ie. below 100 degrees C., or to room temperature), the magnetic tool can be deactivated to terminate the generation of the magnetic field. The wafer can then be easily removed from the tool through the end of the horizontally disposed tube.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A superconductive magnet tool, comprising:
a ceramic tube having a longitudinal axis, the longitudinal axis being oriented substantially horizontally;
a magnet surrounding at least a portion of the ceramic tube, the magnet comprising a coil constructed of an electrically superconducting material;
a heating element contacting a surface of the ceramic tube;
a platter for holding a wafer; and
a support structure for holding the platter within the tube.

2. A tool as in claim 1 wherein the support structure includes an actuator for rotating the platter in a horizontal plane.

3. A tool as in claim 1 wherein the ceramic tube comprises quartz.

4. A tool as in claim 1 wherein the platter is configured to hold the wafer by the force of gravity and without the use of a clamp.

5. A tool as in claim 1 further comprising a vacuum chamber for providing a vacuum within the ceramic tube.

6. A tool as in claim 1 further comprising a magnetic shield surrounding the tube and coil.

7. A superconductive magnet tool, comprising:
a ceramic tube having a longitudinal axis, the longitudinal axis being oriented at an angle of 0 to 30 degrees with respect to a horizontal plane, the ceramic tube having first and second ends that are sealed to form a vacuum chamber;
a vacuum pump for creating a vacuum within the ceramic tube;
a magnet surrounding at least a portion of the ceramic tube, the magnet comprising a coil constructed of a superconductive material;
a heating element wrapped around the ceramic tube;
a platter for holding a wafer; and
a support structure for holding the platter within the tube.

8. A tool as in claim 7 wherein the support structure includes an actuator for rotating the platter in a horizontal plane.

9. A tool as in claim 7 wherein the ceramic tube comprises quartz.

10. A tool as in claim 7 wherein the platter is configured to hold the wafer by the force of gravity and without the use of a clamp.

11. A tool as in claim 7 further comprising a vacuum chamber for providing a vacuum around the magnet.

12. A tool as in claim 7 further comprising a magnetic shield surrounding the tube and magnet.

13. A method of manufacturing a magnetoresistive sensor, comprising:
providing a substrate;
forming a plurality of magnetoresistive sensors on the substrate, the magnetoresistive sensor each including a pinned layer structure;
placing the substrate and plurality of sensors into a magnetic tool, the magnetic tool comprising:
a ceramic tube having a longitudinal axis, the longitudinal axis being oriented substantially horizontally; and
a coil constructed of an electrically superconductive material formed about the ceramic tube;
a heating element formed adjacent to the ceramic tube; and
generating a magnetic field within the magnetic tool to magnetize the pinned layer structures.

14. A method as in claim 13 wherein the magnetic tool further comprises a platter for holding the substrate and magnetoresistive sensors within the ceramic tube.

15. A method as in claim 14 wherein the platter is supported by a support structure that is operable to move the platter laterally into the tube along the axis of the tube without rotating the tube.

16. A method as in claim 14 wherein the platter is supported by a support structure that is operable to move the platter laterally into the tube along the axis of the tube and is also operable to rotate the platter horizontally about a vertical plane.

17. A method as in claim 13 wherein the tube comprises quartz.

18. A method as in claim 13 further comprising, while generating the magnetic field, heating the substrate and sensors.

19. A method as in claim 13, wherein the sensors each include a layer of antiferromagnetic material having a blocking temperature, the method further comprising, while generating a magnetic field, heating the substrate to a temperature near the blocking temperature of the layer of antiferromagnetic material.

20. A method as in claim 13, wherein the sensors each include a layer of antiferromagnetic material having a blocking temperature, the method further comprising, while generating a magnetic field, heating the substrate to a temperature near the blocking temperature of the layer of antiferromagnetic material for a duration of 1 to 3 hours.

21. A method as in claim 13 wherein the longitudinal axis of the tube is oriented at an angle of 0-30 degrees with respect to a horizontal plane.

22. A method as in claim 13 further comprising, while generating a magnetic field, raising the substrate and sensors to a temperature greater than 200 degrees C.

23. A method as in claim 13 further comprising, while generating a magnetic field, raising the substrate and sensors to a temperature of greater than 200 degrees C., and maintaining this temperature and magnetic field generation for a duration of greater than 1 hour.

24. A method as in claim 13 further comprising, generating a magnetic field, raising the substrate and sensors to a temperature of greater than 200 degrees C., and maintaining this temperature and magnetic field generation for a duration of greater than 5 hours.

25. A method of manufacturing a magnetoresistive sensor, comprising:
providing a substrate;
forming a plurality of magnetoresistive sensors on the substrate, the magnetoresistive sensor each including a pinned layer structure;
placing the substrate and plurality of sensors into a magnetic tool, the magnetic tool comprising:
a ceramic tube having a longitudinal axis, the longitudinal axis being oriented substantially horizontally; and
a coil constructed of an electrically superconductive material formed about the ceramic tube;
heating the substrate and sensor to a temperature of 100-300 degrees C.;
generating a magnetic field of 4 to 6 Tesla;
maintaining the magnetic field of 4-6 Tesla and temperature of 100-300 degrees C. for a duration of 1-3 hours; and
cooling the substrate and sensors while maintaining the magnetic field of 4-6 Tesla.

26. A tool as in claim 1 or 7 wherein the heating element comprises an electrically conductive coil wrapped around the ceramic tube.

27. A tool as in claim 1 or 7 wherein the magnet comprises a coil comprising NbTi.

28. A tool as in claim 1 or 7 wherein further comprising a refrigeration system for maintaining the magnet at a temperature of 9 degrees K or less during operation.

29. A tool as in claim 1 or 7 wherein further comprising a refrigeration system including the use of liquid helium as a coolant for cooling the magnet.
